(19) United States
(12) Patent Application Publication
(10) Pub. No.: US 2006/0015820 A1
(43) Pub. Date: Jan. 19, 2006

(54) Fixed window selection

(76) Inventor: Eric Wood, Menlo Oaks, CA (US)

Correspondence Address: KENNETH F. KOZIK, ESQ.;HOLLAND & KNIGHT LLP, 10 ST. JAMES AVENUE, BOSTON, MA, 02116, US

(21) Appl. No.: 11/184,542

(22) Filed: Jul. 19, 2005

(30) Foreign Application Priority Data
Jul. 19, 2004 (EP) EP 04016966.6

(51) Int. Cl. G06F 3/00

(52) U.S. Cl. 715/788; 715/800

(57) ABSTRACT

Methods and apparatus, including computer program products, for fixed window selection. A system for web browsing includes a user interface including a graphical user interface and a processor linked to the user interface, the processor arranged to perform instructions in accordance with a web browser program and to output at the graphical user interface a graphical representation of at least a part of the web browser program in a web browser window, the web browser program including window size program code portions in which at least one predetermined web browser window size is stored, the predetermined web browser window size smaller than a maximum web browser window size and larger than a minimum web browser window size, window size setting program code portions constructed to set the web browser window size in accordance with a selected web browser window size selected from the at least one predetermined web browser window size, and the user interface including a control for selecting by a user the selected web browser window size from the at least one predetermined web browser window size.

### CROSS REFERENCE TO RELATED APPLICATIONS

This application claims the benefit of priority from EP04016966.6, filed on Jul. 19, 2004, the entire content of which is incorporated herein by reference.

### BACKGROUND

The present invention relates to data processing by digital computer, and more particularly to fixed window selection.

The use of electronic media to convey information among networked users has become vital in many applications. One way of conveying such information is through the Internet. The Internet is a distributed network of computers that provides a worldwide information resource to users. A part of the Internet is referred to as the World Wide Web (“web”). The web includes a collection of hypertext documents generally referred to as web pages. Web pages can be linked together using hyperlinks.

Information contained in a web page is generally referred to as content. Typically, web pages are programmed using Hypertext Markup Language (HTML). HTML files are stored on a server.

Typically, a user accesses information on the web using a browser application. A browser is an application program that provides a way to look at and interact with all the information on the web. A web browser is a client program that uses the Hypertext Transfer Protocol (HTTP) to make requests of Web servers throughout the Internet on behalf of the browser user.

A web browser window is typically provided with graphical controls in which the window can be sized as “maximized,” “minimized,” or “intermediate.” In a web browser window, one or more information areas can be present. When a display size of such information exceeds the available space of an information area, the web browser provides scroll bars to the information area, allowing a user to displace the displayed information relative to the information area. Due to this displacement, part of the displayed information will be moved out of the information area, i.e., will be removed from the graphical user interface (GUI). Accessing the contents of information areas using such scroll bars reduces the accessibility of the browser window since operating scroll bars forms an extra step in accessing the contents.

### SUMMARY

The present invention provides methods and apparatus, including computer program products, for fixed window selection.

In general, in one aspect, the invention features a system for web browsing including a user interface including a graphical user interface and a processor linked to the user interface, the processor arranged to perform instructions in accordance with a web browser program and to output at the graphical user interface a graphical representation of at least a part of the web browser program in a web browser window, the web browser program including window size program code portions in which at least one predetermined web browser window size is stored, the predetermined web browser window size smaller than a maximum web browser window size and larger than a minimum web browser window size, window size setting program code portions constructed to set the web browser window size in accordance with a selected web browser window size selected from the at least one predetermined web browser window size, and the user interface including a control for selecting by a user the selected web browser window size from the at least one predetermined web browser window size.

In embodiments, a number of the at least one predetermined web browser window sizes can be smaller than a number of possible web browser window sizes that are smaller than a maximum size and larger than a minimum size. The number of the at least one predetermined web browser window size can be ten or less. The number of the at least one predetermined web browser window size can be five or less.

The web browser window can include a graphical control for inputting by a user at least one user defined web browser window size, and the web browser program can include a size storing program code portion for storing the user defined web browser window size in the window size program code portions.

The at least one predetermined web browser window size can include a size having a width by height corresponding to 800 by 600 pixels, and/or 1024 by 768 pixels and/or 1200 by 1600.

The graphical user interface can include in an operational state of the system a graphical representation of one or more of the predetermined web browser window sizes.

The web browser program can include browsing program code portions for retrieving a web page depending on the selected web browser window size.

In another aspect, the invention features a method for web browsing using a graphical user interface linked to a processor, the processor arranged for performing instructions in accordance with a web browser program and for outputting at the graphical user interface in a web browser window a graphical representation of at least a part of the web browser program, the method including selecting a selected window size from at least one predetermined web browser window size stored in a window size program code portion of the web browser program, setting by a window size setting program code portion of the web browser program, the web browser window size in accordance with the selected web browser window size.

In embodiments, the method can include selecting by the web browser program of a programmed web page to be displayed in a web browser window, wherein the selecting is performed based on the retrieved user selected size.

The invention can be implemented to realize one or more of the following advantages.

A web browser method includes window size and window size setting features that can prevent use of scroll bars in formation areas.

One implementation of the invention provides all of the above advantages.

Other features and advantages of the invention are apparent from the following description, and from the claims.

### BRIEF DESCRIPTION OF THE DRAWINGS

FIG. 1 is a block diagram of an exemplary computer system.

FIG. 2 is a graphical user interface (GUI).

FIG. 3 illustrates a graphical control of a browser window of FIG. 2.

FIG. 4 is a block diagram of a computer system connected to a web server on which different sets of Hypertext Markup Language (HTML) for web pages are stored.

Like reference numbers and designations in the various drawings indicate like

### DETAILED DESCRIPTION

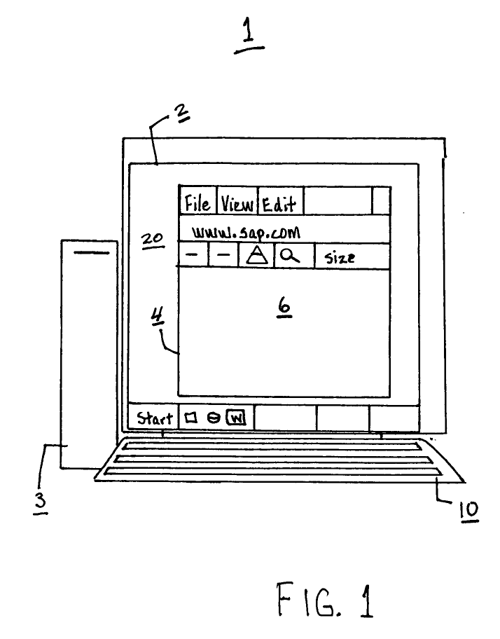

As shown in FIG. 1, an exemplary computer system 1 includes a user interface (UI). The UI has an output interface with a graphical user interface (GUI) 2, which in this example includes a monitor, and an input interface, which includes a keyboard 10. At the input interface, a user of the computer system 1 can input data into the computer system 1 (e.g., by pressing keys on the keyboard 10). At an output interface data can be outputted in a form which can be visually perceived by a user.

The system 1 includes a processor 3 linked to the GUI 2 and to the input interface 10. The processor 3 is arranged to perform instructions in accordance with a web browser program and for outputting at the graphical user interface 2 a web browser window 4 representing information of the web browser program.

The web browser program includes window size program code portions in which at least one predetermined web browser window size is stored. The stored sizes are smaller than a maximum size and larger than a minimum size. The web browser program further includes window size setting program code portions. The window size setting program code portions are constructed to set a size of the web browser window to a selected window size being stored using the size storing program code portions. The maximum size can be, for example, the size of the maximum state provided by the operating system (OS). The maximum size may also be the size in which the web browser window 4 occupies the entire available GUI space 20. The minimum size can be, for example, the threshold size provided in the intermediate state by an operating system.

A particular window size is smaller than the maximum window size in either of the following cases. The first “smaller than maximum” case occurs when the width of the certain window is smaller than the width of the outputable maximum window, while the height of the certain window does not exceed the height of the maximum window. The second “smaller than maximum” case occurs when the height of the certain window is smaller than the height of the maximum window, while the width of the certain window does not exceed the width of the maximum window. Analogously, a certain window size is considered to be larger than the minimum window size in either of the following two cases. The first “larger than minimum” case occurs when the width of the certain window is larger than the width of the minimum window, while the height of the certain window is larger than or equal to the height of the minimum window. The second “larger than minimum” case occurs when the height of the certain window is larger than the height of the minimum window, while the width of the certain window is larger than or equal to the width of the minimum window.

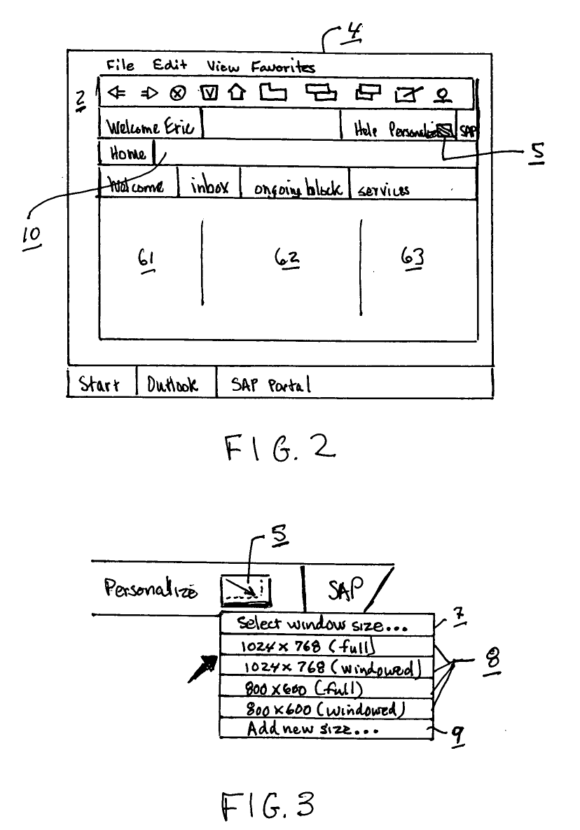

The web browser window 4 includes a web information area 6 in which information from a website can be displayed (e.g., a hypertext document such as a hypertext markup language (HTML) formatted document). In the example shown in FIG. 2, the web browser window 4 includes three web information areas 61, 62 and 63.

The web browser window 4 further includes a first graphical control 5, 7, 8 for outputting a representation of at least one size stored using the window size program code portions for subsequently selecting by a user a stored size from for subsequently setting using the window size setting program code portions the web browser window size in accordance with a selected web browser window size selected from the at least one predetermined web browser window size.

The number of the at least one predetermined web browser window sizes can be smaller than the number of all possible outputtable web browser window sizes that are smaller than the maximum size and larger than the minimum size. For example, operating systems allow the size (width by height) of a program window to be any number of pixels between zero and the dimensions of the GUI, typically 800 by 600 pixels, 1024 by 768 pixels or 1600 by 1200 pixels. The number of the at least one predetermined web browser window sizes can be, for example, ten or less, or five or less.

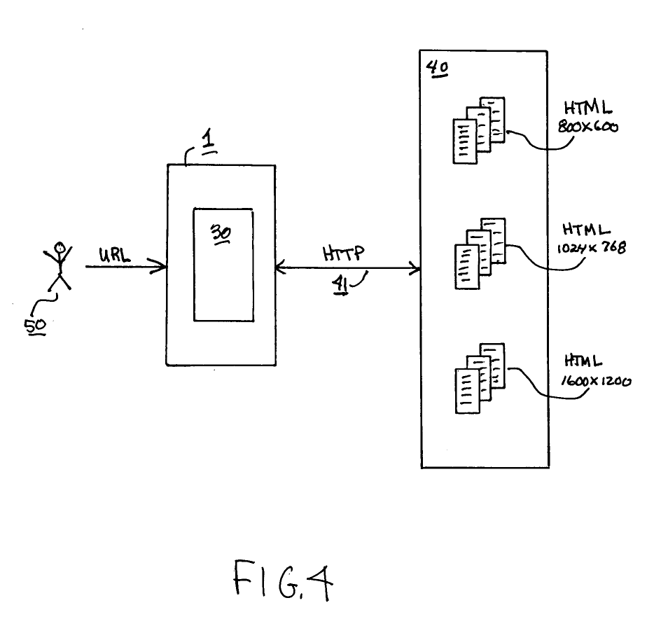

In the example shown in FIG. 3, the number of selectable stored sizes is four. In the shown example, a user can select such stored size by selecting one of a number of options 8 displayed in a pull down menu 7 belonging to the graphical control 5. The different size options to choose from may be a number of pixel combinations, such as 800 by 600 pixels, 1024 by 768 pixels, 1600 by 1200 pixels, and so forth. Such number of pixel combinations can be chosen specifically according to the window sizes that users in practice tend to use. Users tend to prefer a limited number of sizes, typically less than five. For example, such number of pixel combinations can be chosen based on common sizes of personal computer screens, taking into account the space taken up by user interface elements such as operating system bars and menus and tools of the web browser program. This offers the advantage that designers of web pages can tune the sizes of the contents of such pages to the selectable sizes.

The web browser window 4 further includes a second graphical control 9 for inputting by a user to the computer system 1 at least one user defined web browser window size. The web browser program includes size storing code portions for storing the user defined size in the window size program code portions of the web browser program. This offers the advantage for the user that the web browser program is able to easily retrieve the user's custom web browser window sizes.

As shown in FIG. 4, a web browser program 30 is shown running on a computer system 1. The computer system 1 is connected to a web server 40 by an Internet connection 41. On the web server 40, different sets of HTML files for web pages are stored. Using a first set, designated by “HTML 800×600”, web pages of a web site are programmed, wherein each page is programmed for display 800×600 pixels. Using a second set, designated by “HTML 1024×768”, the same web pages of the same web site are programmed wherein each page for display is 1024×768 pixels. Using a third set “HTML 1600×1200” relates to the web pages to be displayed as 1600×1200 pixels.

It is assumed that the computer system 1 is in a state in which the web browser window 4 is outputted at the GUI in a user selected size stored in the window size program code portions of the web browser program 30. When, in this state, a user 50 wants to view information in one of the web pages, the user 50 provides the web page's universal resource locator (URL) address to instruct the web browser program 30 to access the web page. If necessary, the web browser program 30 then retrieves the values of the user selected size of the web browser window 4 from the window size program code portions. Based on the user selected size and the URL, the web browser program is able to locate a suitable web page on the web server 40. For example, the URL provided by the user 50 can point to a web page that contains an index of available sets of web pages, their URLs and the window sizes corresponding to each set. The web browser program can retrieve this index and retrieve a set based on the information in the index and the size of the browser window. In case the sizes corresponding to the sets do not correspond to the selected window size, the web browser program can determine which set of web pages best suits the user selected size of the web browser window 4, for example, in that the use of scroll bars would be prevented as much as possible. In the shown example, a choice can be made from the three different sets of HTML files, i.e. the sets HTML 800×600, HTML 1024×768 or HTML 1600×1200. Based on a located web page, the web browser program 30 makes an HTTP request to the web server 40 to view the located web page, after which the web server 40 provides an HTTP response to the web browser program 30 to permit the located web page to be displayed. Then, the web browser program 30 is able to instruct the processor 3 to output the located web page at the GUI 2 in the information areas of the web browser window 4.

Next, an example is considered in which, in a state in which the web page is thus outputted, the user 50 selects via a graphical control, such as shown in FIG. 3, another size stored in the window size program code portions of the web browser program 30. In such case, the web browser program 30 can retrieve the new user selected size of the web browser window 4 and can output the web browser window with the new size. Furthermore, based on the new size and the URL, the web browser program 30 is able to determine if a different web page would be available on the web server 40, which would better suit the new user selected size of the web browser window 4. If so, such a better suited web page can be located and displayed.

Embodiments of the invention can be implemented in digital electronic circuitry, or in computer hardware, firmware, software, or in combinations of them. Embodiments of the invention can be implemented as a computer program product, i.e., a computer program tangibly embodied in an information carrier, e.g., in a machine readable storage device or in a propagated signal, for execution by, or to control the operation of, data processing apparatus, e.g., a programmable processor, a computer, or multiple computers. A computer program can be written in any form of programming language, including compiled or interpreted languages, and it can be deployed in any form, including as a stand alone program or as a module, component, subroutine, or other unit suitable for use in a computing environment. A computer program can be deployed to be executed on one computer or on multiple computers at one site or distributed across multiple sites and interconnected by a communication network.

Method steps of embodiments of the invention can be performed by one or more programmable processors executing a computer program to perform functions of the invention by operating on input data and generating output. Method steps can also be performed by, and apparatus of the invention can be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. Information carriers suitable for embodying computer program instructions and data include all forms of non volatile memory, including by way of example semiconductor memory devices, e.g., EPROM, EEPROM, and flash memory devices; magnetic disks, e.g., internal hard disks or removable disks; magneto optical disks; and CD ROM and DVD ROM disks. The processor and the memory can be supplemented by, or incorporated in special purpose logic circuitry.

It is to be understood that the foregoing description is intended to illustrate and not to limit the scope of the invention, which is defined by the scope of the appended claims. Other embodiments are within the scope of the following claims.

What is claimed is:

1. A system for web browsing comprising:
a user interface including a graphical user interface and a processor linked to the user interface, the processor arranged to perform instructions in accordance with a web browser program and to output at the graphical user interface a graphical representation of at least a part of the web browser program in a web browser window, the web browser program comprising:
window size program code portions in which at least one predetermined web browser window size is stored, the predetermined web browser window size smaller than a maximum web browser window size and larger than a minimum web browser window size;
window size setting program code portions constructed to set the web browser window size in accordance with a selected web browser window size selected from the at least one predetermined web browser window size; and
the user interface including a control for selecting by a user the selected web browser window size from the at least one predetermined web browser window size.

2. The computer system of claim 1 a number of the at least one predetermined web browser window sizes is smaller than a number of possible web browser window sizes that are smaller than a maximum size and larger than a minimum size.

3. The computer system of claim 3 wherein the number of the at least one predetermined web browser window size is ten or less.

4. The computer system of claim 3 wherein the number of the at least one predetermined web browser window size is five or less.

5. The computer system of claim 1 wherein the web browser window comprises a graphical control for inputting by a user at least one user defined web browser window size, and the web browser program includes a size storing program code portion for storing the user defined web browser window size in the window size program code portions.

6. The computer system of claim 1 wherein the at least one predetermined web browser window size comprises a size having a width by height corresponding to 800 by 600 pixels, and/or 1024 by 768 pixels and/or 1200 by 1600.

7. The computer system of claim 1 wherein the graphical user interface includes in an operational state of the system a graphical representation of one or more of the predetermined web browser window sizes.

8. The computer system of claim 1 the web browser program further includes browsing program code portions for retrieving a web page depending on the selected web browser window size.

9. A method for web browsing using a graphical user interface linked to a processor, the processor arranged for performing instructions in accordance with a web browser program and for outputting at the graphical user interface in a web browser window a graphical representation of at least a part of the web browser program, the method comprising:
selecting a selected window size from at least one predetermined web browser window size stored in a window size program code portion of the web browser program;
setting by a window size setting program code portion of the web browser program, the web browser window size in accordance with the selected web browser window size.

10. The method of claim 9 further comprising selecting by the web browser program of a programmed web page to be displayed in a web browser window, wherein the selecting is performed based on the retrieved user selected size.
